(19) United States
(12) Patent Application Publication
(10) Pub. No.: US 2026/0058752 A1
(43) Pub. Date: Feb. 26, 2026

(54) ELECTRONIC DEVICE AND METHOD OF TRANSMITTING PROTOCOL DATA UNIT

(71) Applicant: Samsung Electronics Co., Ltd., Suwon-si (KR)

(72) Inventor: Junsu CHOI, Suwon-si (KR)

(21) Appl. No.: 19/341,902

(22) Filed: Sep. 26, 2025

Related U.S. Application Data
(63) Continuation of application No. PCT/KR2025/010076, filed on Jul. 10, 2025.

(30) Foreign Application Priority Data
Aug. 21, 2024 (KR) 10-2024-0112168
Sep. 25, 2024 (KR) 10-2024-0129797

(51) Int. Cl. H04L 1/00; H04L 5/00; H04W 80/02

(52) U.S. Cl. CPC H04L 1/0003; H04L 5/0053; H04W 80/02

(57) ABSTRACT

An electronic device includes: a wireless communication module, comprising communication circuitry, at least one processor, comprising processing circuitry, memory storing instructions, wherein at least one processor, individually or collectively, is configured to execute the instructions and to cause the electronic device to: independently allocate, to a plurality of spatial streams, a plurality of medium access control (MAC) protocol data units (MPDUs) included in a physical layer convergence procedure (PLCP) PDU (PPDU); and transmit the PPDU to an external electronic device through the wireless communication module by applying different modulation and coding schemes (MCSs) to the plurality of spatial streams.

### CROSS-REFERENCE TO RELATED APPLICATIONS

This application is a continuation of International Application No. PCT/KR2025/010076 designating the United States, filed on Jul. 10, 2025, in the Korean Intellectual Property Receiving Office and claiming priority to Korean Patent Application No. 10-2024-0112168, filed on Aug. 21, 2024, and Korean Patent Application No. 10-2024-0129797, filed on Sep. 25, 2024, in the Korean Intellectual Property Office, the disclosures of each of which are incorporated by reference herein in their entireties.

### BACKGROUND

### 1. Field

The disclosure relates to an electronic device and a method of transmitting a protocol data unit (PDU).

### 2. Description of Related Art

With the advent of electronic devices such as smartphones, tablet PCs, or laptops, the demand for high-speed wireless connectivity has exploded. These trends and the growing demand for high-speed wireless connectivity have firmly established the institute of electrical and electronics engineers (IEEE) 802.11 wireless communication standard as a representative and universal high-speed wireless communication standard in the information technology (IT) industry.

Following wireless fidelity (Wi-Fi) 7 (e.g., IEEE 802.11bn), standardization discussions are underway for Wi-Fi 8 (e.g., IEEE 802.11bn). In Wi-Fi 8, various technologies are being discussed to improve the efficiency of a Wi-Fi network and provide predictable and deterministic service quality to each user in various congested situations. In particular, in Wi-Fi 8, discussions on cooperative transmission and reception technology between access points (APs) and unequal modulation (UEQM) technology are actively underway.

The above information may be presented as the related art to help with the understanding of the disclosure. No assertion or determination is made as to whether any of the foregoing description may be applied as prior art regarding this disclosure.

### SUMMARY

According to example embodiments, an electronic device includes: a wireless communication module comprising communication circuitry, at least one processor including processing circuitry, memory storing instructions, wherein at least one processor, individually or collectively, is configured to execute the instructions and to cause the electronic device to independently allocate, to a plurality of spatial streams, a plurality of medium access control (MAC) protocol data units (MPDUs) included in a physical layer convergence procedure (PLCP) PDU (PPDU). The at least one processor, individually or collectively is configured to execute the instructions and to cause the electronic device to transmit the PPDU to an external electronic device through the wireless communication module by applying different modulation and coding schemes (MCSs) to the plurality of spatial streams.

According to example embodiments, a method performed by an electronic device includes: independently allocating, to a plurality of spatial streams, a plurality of MPDUs included in a PPDU. The method includes transmitting the PPDU to an external electronic device by applying different MCSs to the plurality of spatial streams.

According to example embodiments, an electronic device includes: a wireless communication module comprising communication circuitry, at least one processor including processing circuitry, and memory storing instructions, wherein at least one processor, individually or collectively, is configured to execute the instructions and to cause the electronic device to based on a modulation and coding scheme (MCS) applied to a plurality of spatial streams for transmission of a physical layer convergence procedure PDU (PPDU), verify communication quality for each of the plurality of spatial streams. The at least one processor, individually or collectively, is configured to execute the instructions and to cause the electronic device to determine the MCS in a different manner according to an MCS determination mode based on a difference in the communication quality for each of the plurality of spatial streams.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 is a diagram illustrating an example of a wireless local area network (WLAN) system according to various embodiments;

FIG. 2 is a diagram illustrating an example of a WLAN system according to various embodiments;

FIG. 3A is a diagram illustrating an example method of transmitting a protocol data unit (PDU) by applying the same modulation and coding scheme (MCS) to a plurality of spatial streams according to a first MCS determination mode, according to various embodiments;

FIG. 3B is a diagram illustrating an example method of transmitting a PDU by applying different MCSs to a plurality of spatial streams according to a second MCS determination mode, according to various embodiments;

FIG. 4 is a block diagram illustrating an example configuration of the transmitting station and the receiving station illustrated in FIGS. 3A and 3B according to various embodiments;

FIG. 5 is a diagram illustrating a physical layer convergence procedure (PLCP) PDU (PPDU) transmission method according to various embodiments;

FIGS. 6A and 6B are diagrams illustrating an example structure of a PPDU, according to various embodiments;

FIG. 7 is a diagram illustrating an example operation of allocating a medium access control (MAC) PDU (MPDU) to a spatial stream, according to various embodiments;

FIGS. 8A and 8B include a flowchart and a diagram illustrating an example method of searching for an optimal MCS for each spatial stream, according to various embodiments;

FIG. 9 is a diagram illustrating an example method of applying an MCS by variably applying an MCS determination mode, according to various embodiments;

FIG. 10 is a flowchart illustrating an example PDU transmission method, according to various embodiments; and

FIG. 11 is a block diagram illustrating an example electronic device in a network environment, according to various embodiments.

### DETAILED DESCRIPTION

Hereinafter, various example embodiments will be described in greater detail with reference to the accompanying drawings. When describing the example embodiments with reference to the accompanying drawings, like reference numerals refer to like elements and a repeated description related thereto may not be provided.

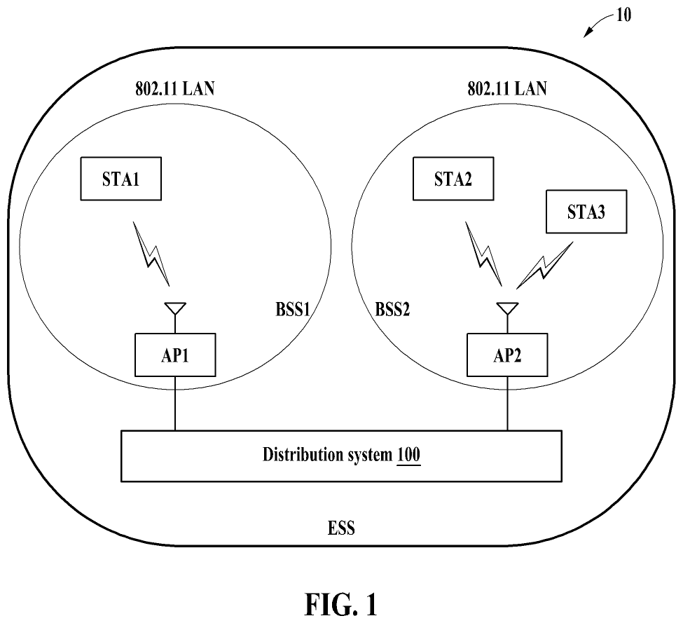

FIG. 1 is a diagram illustrating an example of a wireless local area network (WLAN) system according to various embodiments.

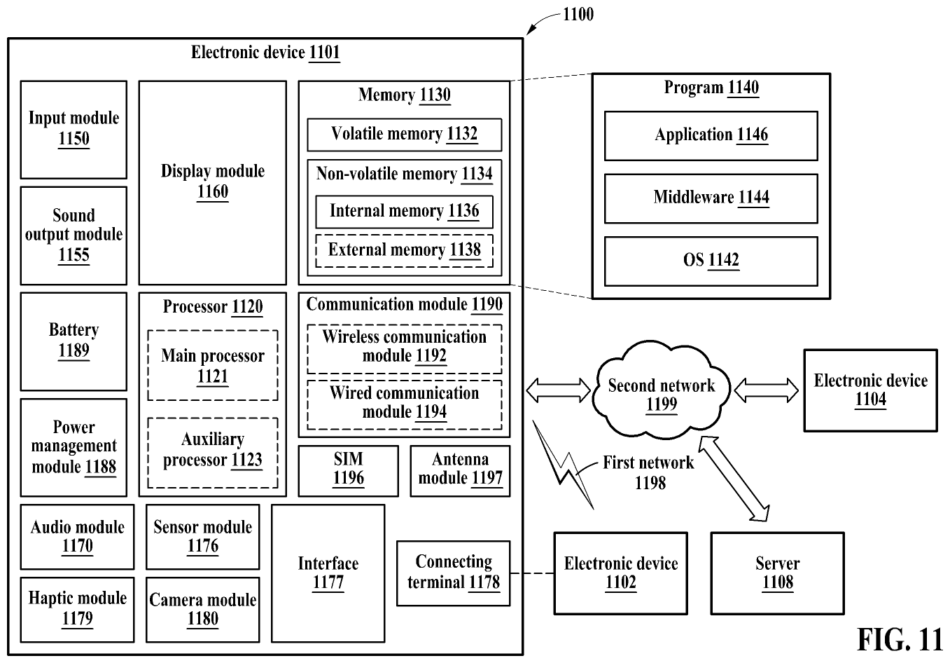

Referring to FIG. 1, according to various embodiments, a WLAN system 10 may be in an infrastructure mode in which an access point (AP) is present in a WLAN structure conforming to an institute of electrical and electronic engineers (IEEE) 802.11 standard. The WLAN system 10 may include at least one basic service set (BSS), for example, BSS1 and BSS2. The BSS1 or BSS2 may be a set of an AP and a station (STA, e.g., an electronic device 1101, 1102, or 1104 of FIG. 11), which may successfully synchronize with each other to communicate with each other. BSS1 may include AP1 and STA1, and BSS2 may include AP2 and two or more STA2 and STA3 that may be coupled to one AP2.

According to various embodiments, the WLAN system 10 may include at least one STA (e.g., STA1 to STA3), an AP (e.g., AP1 and AP2) that provides a distribution service, and a distribution system 100 that connects a plurality of APs (e.g., AP1 and AP2). The distribution system 100 may implement an extended service set (ESS) by connecting a plurality of BSSs (e.g., BSS 1 and BSS 2). The ESS may be used as a term to denote one network including one or more APs (e.g., AP1 and AP2) connected via the distribution system 100. The APs (e.g., AP1 and AP2) included in one ESS may have the same service set identification (SSID).

According to various embodiments, the STAs (e.g., STA1 to STA3) may be an arbitrary functional medium including a medium access control (MAC) and wireless-medium physical layer (PHY) interface conforming to the IEEE 802.11 standard. The term “STA” (e.g., STA1 to STA3) may be used as including both an AP-STA and a non-AP STA. The STA (e.g., STA1 to STA3) may be referred to by various names, such as an electronic device, a mobile terminal, a wireless device, a wireless transmit/receive unit (WTRU), user equipment (UE), a mobile station (MS), a mobile subscriber unit, or simply, a user.”

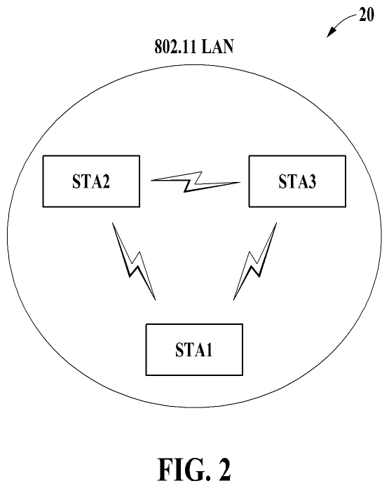

FIG. 2 is a diagram illustrating an example of a WLAN system according to various embodiments.

Referring to FIG. 2, according to various embodiments, a WLAN system 20 may be in an ad-hoc mode in which communication is performed by setting a network between STAs without an AP in a structure of a WLAN of the IEEE 802.11 standard, unlike the WLAN system 10 of FIG. 1. The WLAN system 20 may include a BSS operating in an ad-hoc mode, that is, an independent BSS (IBSS).

According to various embodiments, since the IBSS does not include an AP, a centralized management entity that performs a management function at a center may not exist. In the IBSS, STAs (e.g., STA 1 and STA 2) may be managed in a distributed manner. In the IBSS, all STAs may be mobile STAs, and a stand-alone network (or a self-contained network) may be configured since access to a distribution system (e.g., the distribution system 100 of FIG. 1) is not allowed.

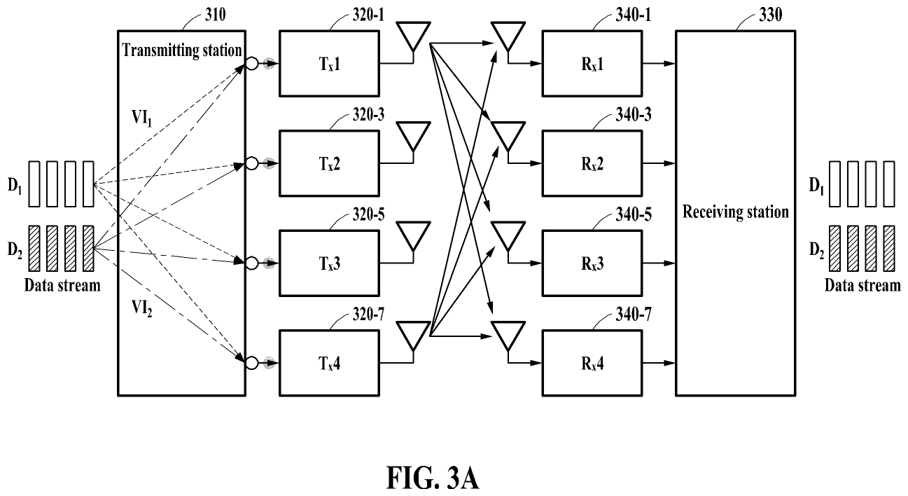

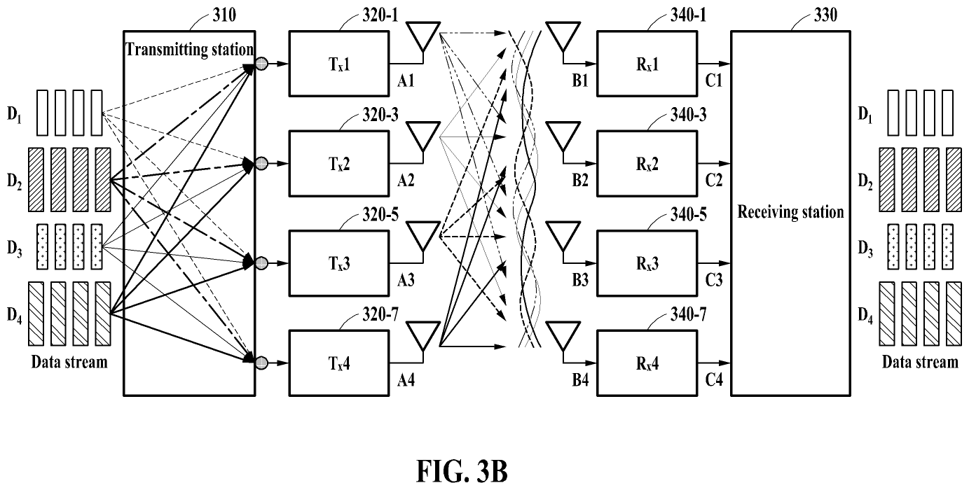

FIG. 3A is a diagram illustrating an example method of transmitting a protocol data unit (PDU) by applying the same modulation and coding scheme (MCS) to a plurality of spatial streams according to a first MCS determination mode, according to various embodiments.

Referring to FIG. 3A, according to an embodiment, a transmitting station 310 (e.g., STA1 to STA3 of FIG. 2) and a receiving station 330 (e.g., STA1 to STA3 of FIG. 2) may communicate with each other in a multi-input multi-output (MIMO) system. That is, the transmitting station 310 and the receiving station 330 may transmit and receive a plurality of data streams (e.g., D1 to D4) using a plurality of antennas (e.g., antennas 320-1 to 320-7 of the transmitting station 310 and antennas 340-1 to 340-7 of the receiving station 330).

According to an embodiment, the transmitting station 310 may include the plurality of antennas 320-1 and 320-3. The receiving station 330 may include the plurality of antennas 340-1 and 340-3. The antennas 320-1 to 320-3 and the antennas 340-1 and 340-3 may be designed so that interference does not occur between the plurality of data streams.

According to an embodiment, in the MIMO system, spatially separated channels may be generated through the plurality of antennas (e.g., the antennas 320-1 to 320-7 of the transmitting station 310 and the antennas 340-1 and 340-7 of the receiving station 330). The transmitting station 310 may transmit a data stream to the receiving station 330 through the spatially separated channels. The data stream transmitted through the spatially separated channels may be a spatial stream. The spatial stream may be formed for each antenna.

According to an embodiment, data (e.g., a physical layer convergence procedure (PLCP) PDU (PPDU) and/or a MAC PDU (MPDU)) may be overlappingly transmitted through the plurality of spatial streams. One MPDU may be separated and distributed to each antenna (e.g., 320-1 to 320-7). For example, a first portion of the MPDU may be distributed to the antenna 320-1, a second portion of the MPDU may be distributed to the antenna 320-3, a third portion of the MPDU may be distributed to the antenna 320-5, and a fourth portion of the MPDU may be distributed to the antenna 320-7. The result of adding the first to fourth portions of the MPDU may be the same as the whole of the MPDU. The antennas 320-1 to 320-7 may transmit, to the antennas 340-1 to 340-7 of the receiving station 330, the MPDU distributed to each of the antennas 320-1 to 320-7 through their own spatial streams. In the case of PPDU transmission, the above-described method may be applied substantially the same for each of the plurality of MPDUs included in the PPDU. For example, a first MPDU included in the PPDU may be separated and distributed to each antenna (e.g., 320-1 to 320-7). Additionally, a second MPDU (e.g., different from the first MPDU) included in the PPDU may be separated and distributed to each antenna (e.g., 320-1 to 320-7).

According to an embodiment, when data (e.g., PPDU and/or MPDU) transmitted from the transmitting station 310 is received, the receiving station 330 may transmit an acknowledgement (ACK) regarding whether the transmission of the data to the transmitting station 310 is successful. For example, the receiving station 330 may check whether the transmission of the MPDU is successful through a frame check sequence (FCS) field included in the MPDU. When it is checked whether the transmission is successful, the receiving station 330 may transmit the ACK to the transmitting station 310. The transmitting station 310 may check whether the transmission of the transmitted data is successful based on the ACK received from the receiving station 330.

According to an embodiment, the quality of a channel may be determined based on the degree of isolation between the antennas 320-1 to 320-7. For example, when the degree of isolation between the antennas 320-1 to 320-7 is high, the channel quality may be high. When the quality of a channel is high, the communication quality (e.g., signal-to-noise ratio (SNR)) for each spatial stream may be formed similarly. When the degree of isolation between the antennas 320-1 to 320-7 is low, the quality of a channel may be low. When the quality of a channel is low, a large difference may occur in the SNR for each spatial stream. As described above, the occurrence of the large difference in the SNR for each spatial stream may indicate the occurrence of distortion between channels of antennas.

According to an embodiment, the transmitting station 310 may apply the same MCS to the spatial streams of the antennas (e.g., 320-1 to 320-7). The MCS may be determined by a channel of an antenna with the lowest quality. When the distortion between channels of the antennas (e.g., 320-1 to 320-7) occurs, applying the MCS to the channel of the antenna with the lowest quality may cause significant inefficiency in terms of transmission rate and efficiency of the data stream. For example, when the channel quality of the antenna 320-1 is the lowest so that 16-quadrature amplitude modulation (QAM) is applied to the spatial streams of all the antennas 320-1 to 320-7, although an MCS (e.g., 256-QAM or 4K-QAM) with a transmission rate faster than 16-QAM may be applied to the antennas (e.g., 320-3 to 320-7), other than the antenna 320-1, inefficiency of not applying the MCS with a transmission rate faster than 16-QAM may occur. For example, when the same MCS is applied to all spatial streams, the above-described inefficiency may occur, so in wireless fidelity (Wi-Fi) 8, a method (e.g., uniform modulation (UEM)) of applying different MCSs to the spatial streams is being discussed. This is described in detail with reference to FIG. 3B.

FIG. 3B is a diagram illustrating an example method of transmitting a PDU by applying different MCSs to a plurality of spatial streams according to a second MCS determination mode, according to various embodiments.

Referring to FIG. 3B, according to an embodiment, the transmitting station 310 may apply different MCSs to the spatial streams of the antennas (e.g., 320-1 to 320-7). The transmitting station 310 may apply an optimal MCS (e.g., an MCS determined by considering a transmission rate and communication stability) for each spatial stream of the antennas (e.g., 320-1 to 320-7). For example, the transmitting station 310 may apply 16-QAM to the spatial stream of the antenna 320-1, 256-QAM to the antenna 320-3, 4K-QAM to the antenna 320-5, and 8K-QAM to the antenna 320-7.

However, when applying different MCSs to the spatial streams, the following problems may occur when the existing PDU transmission structure is followed.

According to an embodiment, the existing PDU transmission structure may be a structure in which the plurality of spatial streams is involved in transmitting data (e.g., MPDU) as described with reference to FIG. 3A. For example, the transmitting station 310 may distribute one MPDU to the plurality of antennas (e.g., 320-1 to 320-7) and transmit each portion (e.g., first to fourth portions of the MPDU) to the receiving station 330 through different spatial streams. When the spatial streams are received, the receiving station 330 may output an ACK to the transmitting station 310. The transmitting station 310 may check whether the transmission of the spatial streams is successful based on the ACK. When the same MCS is applied (e.g., a first MCS determination mode) to all the spatial streams (e.g., the spatial streams of the antennas (e.g., 320-1 to 320-7), the transmitting station 310 may verify a packet error rate (PER) of a spatial stream in a certain MCS. This may be because a certain MCS is applied equally to all the spatial streams, so when a transmission error occurs in the MPDU transmitted from the receiving station 330, the transmission error may be determined to be a packet error in the certain MCS. However, when different MCSs are applied (e.g., a second MCS determination mode) to all the spatial streams (e.g., the spatial streams of the antennas (e.g., 320-1 to 320-7), the transmitting station 310 may not verify a PER in a certain MCS. This may be because different MCSs are applied to all the spatial streams, so when a transmission error occurs in the MPDU transmitted from the receiving station 330, the transmission error may not be determined to be a packet error of one of the different MCSs. As described above, when the PER in a certain MCS may not be verified, the following problems may occur.

According to an embodiment, the transmitting station 310 may search for an MCS to be applied to the spatial stream in real time. The channel quality of the antennas (e.g., 320-1 to 320-7) may change over time based on the mobility of the transmitting station 310, the receiving station 330, and/or various obstacles. The transmitting station 310 may search for an optimal MCS (e.g., an MCS having the fastest transmission rate, an MCS having the highest stability, and/or an MCS determined through a trade-off between the transmission rate and stability) in real time based on the channel quality of the antennas (e.g., 320-1 to 320-7), which changes over time. There may be various real-time MCS search methods, but for example, a sampling-based search method may be generally used. Hereinafter, the sampling-based search method is described in greater detail.

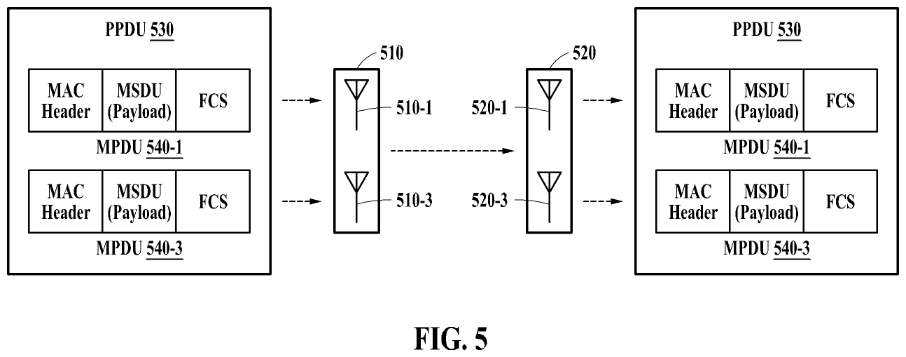

According to an embodiment, the transmitting station 310 may monitor the PER of the data transmitted according to a current MCS and determine whether the MCS needs to be changed. The transmitting station 310 may randomly try high and low MCSs based on the current MCS and monitor the PER for each MCS. The transmitting station 310 may determine whether a better MCS than the current MCS may be used or whether the MCS needs to be lowered in real time based on the PER for each MCS. For example, when the data is transmitted to the receiving station 330 through a spatial stream to which a certain MCS is applied, the transmitting station 310 must be able to check whether the transmission of the transmitted data is successful according to the certain MCS. In the existing PDU transmission structure, when different MCSs are applied for each spatial stream, the PER of a certain MCS may not be verified, resulting in a problem that the sampling-based search method may not be used. To address this problem, it may be necessary to change the existing PDU transmission structure. This is described in greater detail below with reference to FIG. 5.

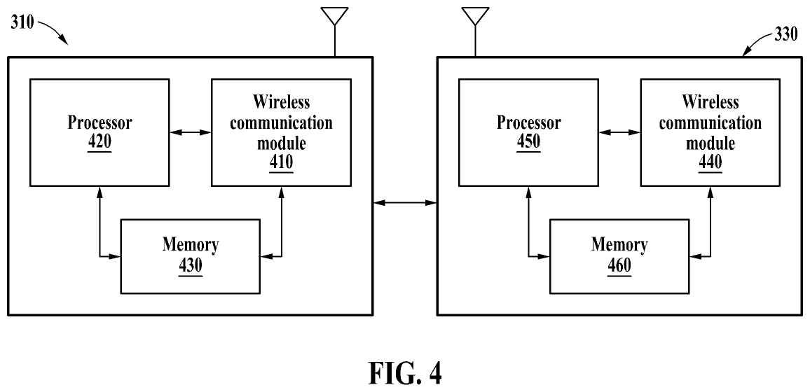

FIG. 4 is a block diagram illustrating an example configuration of the transmitting station and the receiving station illustrated in FIGS. 3A and 3B according to various embodiments.

Referring to FIG. 4, the transmitting station 310 may include a wireless communication module (e.g., including communication circuitry) 410, a processor (e.g., including processing circuitry) 420, and memory 430. The wireless communication module 410 may be configured to transmit and receive a wireless signal. The wireless communication module 410 may be a Wi-Fi chipset. The wireless communication module 410 may support multiple bands of 2.4 gigahertz (GHz), 5 GHZ, and/or 6 GHz. The processor 420 may be operatively connected to the wireless communication module 410. The memory 430 may be electrically connected to the processor 420 and store one or more instructions executable by the processor 420. The transmitting station 310 may correspond to an electronic device (e.g., an electronic device 1101 of FIG. 11) to be described with reference to FIG. 11. Therefore, a duplicate description of such described in FIG. 11 may not be repeated here. The operations performed by the transmitting station 310 may include an operation performed by the wireless communication module 410 and an operation performed by the processor 420 through the wireless communication module 410.

According to an embodiment, the memory 430 may include one or more memories. The instructions stored in the memory 430 may be stored in one memory. The instructions stored in the memory 430 may be divided and stored in a plurality of memories. The instructions stored in the memory 430 may be executed by the processor 420 to cause the transmitting station 310 to perform and/or control the operations of the transmitting station 310 described with reference to FIGS. 1 to 3B and the operations of the transmitting station 310 to be described in greater detail below with reference to FIGS. 5 to 11.

According to an embodiment, the processor 420 may be implemented as a system on chip (SoC) or circuitry (e.g., processing circuitry) such as an integrated circuit (IC). The processor 420 may include at least one processor. For example, the processor 420 may include a combination of one or more processors, such as a central processing unit (CPU), a graphics processing unit (GPU), a micro processing unit (MPU), an AP, and a communication processor (CP). The instructions stored in the memory 430 may be executed by one processor to cause the transmitting station 310 to perform and/or control the operations of the transmitting station 310 described with reference to FIGS. 1 to 3B and the operations of the transmitting station 310 to be described with reference to FIGS. 5 to 11. The instructions stored in the memory 430 may be executed by a plurality of processors to cause the transmitting station 310 to perform and/or control the operations of the transmitting station 310 described with reference to FIGS. 1 to 3B and the operations of the transmitting station 310 to be described in greater detail below with reference to FIGS. 5 to 11. Thus, the processor 420 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

According to an embodiment, the receiving station 330 may include a wireless communication module (e.g., including communication circuitry) 440, a processor (e.g., including processing circuitry) 450, and memory 460. The wireless communication module 440 may be configured to transmit and receive a wireless signal. The wireless communication module 440 may be a Wi-Fi chipset. The wireless communication module 440 may support multiple bands of 2.4 GHz, 5 GHZ, and/or 6 GHz. The processor 450 may be operatively connected to the wireless communication module 440. The memory 460 may be electrically connected to the processor 450 and store one or more instructions executable by the processor 450. The description of the processor 420 above applies equally to the processor 450.

FIG. 5 is a diagram illustrating an example PPDU transmission method according to various embodiments.

Referring to FIG. 5, according to an embodiment, a transmitting station 510 (e.g., the transmitting station 310 of FIGS. 3A and 3B) and a receiving station 520 (e.g., the receiving station 330 of FIGS. 3A and 3B) may communicate with each other in a MIMO system. The transmitting station 510 may include a plurality of antennas 510-1 and 510-3 (e.g., the antennas 320-1 to 320-7 of FIG. 3B). The receiving station 520 may include a plurality of antennas 520-1 and 520-3 (e.g., the antennas 340-1 to 340-7 of FIG. 3B). The transmitting station 510 and the receiving station 520 may form spatially separated channels through a plurality of antennas. The transmitting station 510 may generate spatial streams through channels generated for each antenna. For example, the transmitting station 510 may generate each channel of the antenna 510-1 and the antenna 510-3. The spatial stream transmitted through the channel of the antenna 510-1 and the spatial stream transmitted through the channel of the antenna 510-3 may be separated from each other.

According to an embodiment, the transmitting station 510 may transmit a data stream (e.g., a PPDU 530) to the receiving station 520 through a spatial stream. A method of transmitting the PPDU 530 from the transmitting station 510 to the receiving station 520 is described in greater detail below.

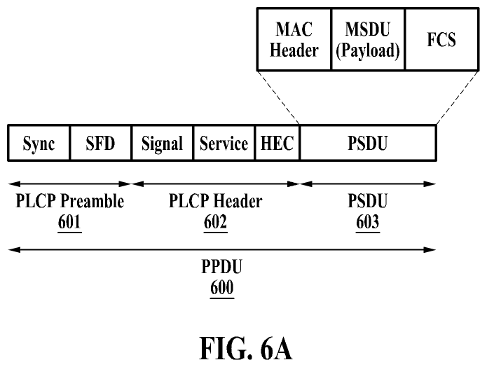

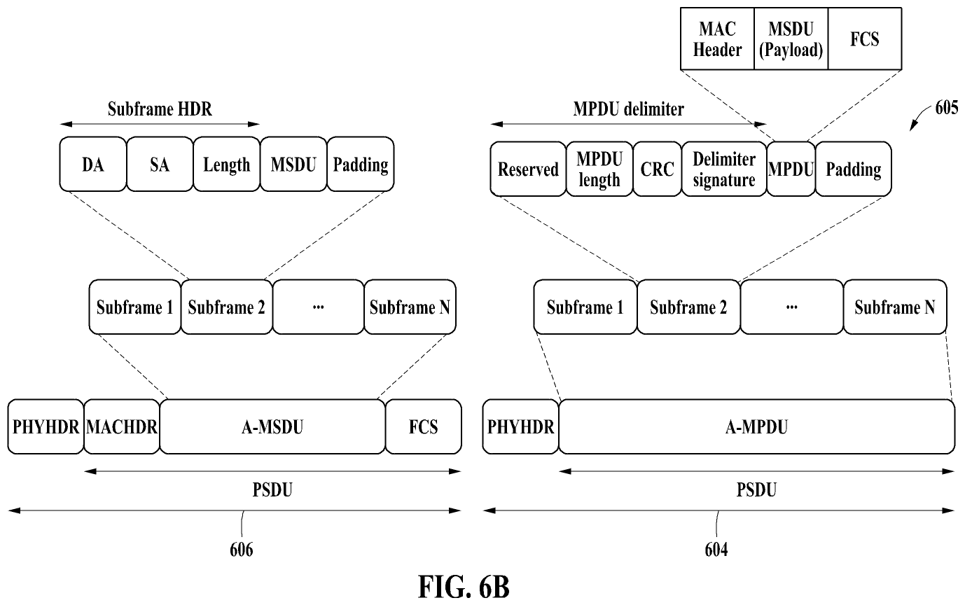

According to an embodiment, the transmitting station 510 may aggregate a plurality of MPDUs 540-1 and 540-3, thereby generating the PPDU 530. The MPDUs 540-1 and 540-3 may each include a MAC header, a MAC service data unit (MSDU), and an FCS field. Through the FCS field, Wi-Fi devices (e.g., the transmitting station 510 and/or the receiving station 520) may inspect whether an error exists in data included in the MPDUs 540-1 and 540-3. A specific structure of the PPDU 530 generated by aggregating the plurality of MPDUs 540-1 and 540-3 is described in greater detail below with reference to FIGS. 6A and 6B.

According to an embodiment, the transmitting station 510 may independently allocate, to a plurality of spatial streams, the plurality of MPDUs 540-1 and 540-3 included in the PPDU 530. Independent allocation may indicate that one MPDU is completely allocated to one spatial stream, as opposed to one MPDU being allocated separately to the plurality of spatial streams. For example, the transmitting station 510 may allocate the MPDU 540-1 to a spatial stream of the antenna 510-1 and may allocate the MPDU 540-3 to a spatial stream of the antenna 510-3.

According to an embodiment, the transmitting station 510 may apply different MCSs to the plurality of spatial streams (e.g., the MPDUs 540-1 and 540-3 are independently allocated). The MCS may be determined according to the quality of each channel. In a first MCS determination mode (e.g., when applying the same MCS to a plurality of spatial streams), the MCS may be determined by a channel of an antenna with the lowest quality. In a second MCS determination mode (e.g., when applying different MCSs to a plurality of spatial streams), the MCS may be determined for each channel of antennas corresponding to spatial streams. Accordingly, a more advanced MCS may be used for a channel with a high quality than a channel with a low quality. In the second MCS determination mode, inefficiency (e.g., inefficiency in terms of transmission rate and efficiency of a data stream due to the same MCS being determined by a channel of an antenna with the lowest quality) in the first MCS determination mode may be improved. For example, in the first MCS determination mode, even when the channel quality of the antenna 510-1 is higher than that of the antenna 510-3, depending on the quality of the antenna 510-3, 256-QAM may be applied equally, thereby causing inefficiency. In the second MCS determination mode, the transmitting station 510 may apply 4K-QAM to the spatial stream of the antenna 510-1 and apply 256-QAM to the spatial stream of the antenna 510-3.

According to an embodiment, the transmitting station 510 may transmit the PPDU 530 to the receiving station 520 through the plurality of spatial streams (e.g., different MCSs are applied). Since the MPDUs 540-1 and 540-3 are independently allocated to the spatial streams, the receiving station 520 may verify the FCS field for each of the MPDUs 540-1 and 540-3. For example, it may be assumed that 4K-QAM is applied to the spatial stream (e.g., the MPDU 540-1 is allocated) of the antenna 510-1 and 256-QAM is applied to the spatial stream (e.g., the MPDU 540-3 is allocated) of the antenna 510-3. The receiving station 520 may receive the MPDU 540-1 through the spatial stream of the antenna 520-1. The receiving station 520 may verify the FCS field of the MPDU 540-1 and check whether the transmission of the MPDU 540-1 is successful in 4K-QAM. In the case of the MPDU 540-3, whether the transmission is successful may be checked in substantially the same manner as the MPDU 540-1. The receiving station 520 may transmit, to the transmitting station 510, a plurality of ACKs regarding whether the transmission of each of the plurality of MPDUs 540-1 and 540-3 is successful.

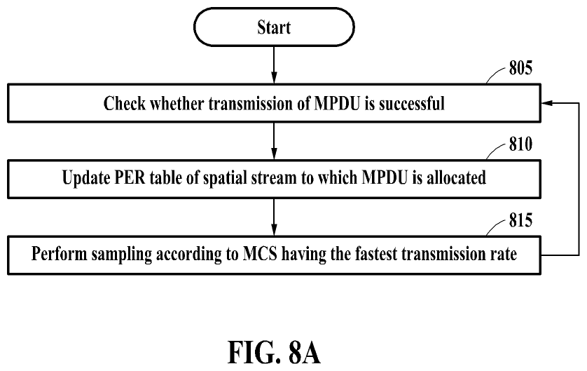

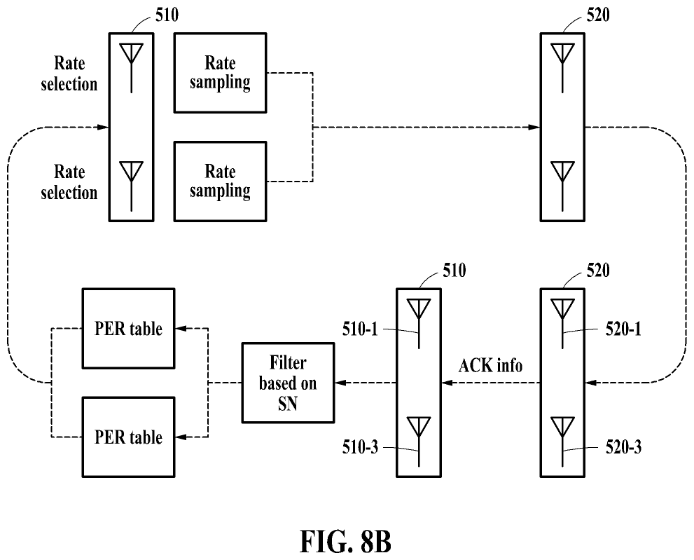

According to an embodiment, the transmitting station 510 may receive, from the receiving station 520, the plurality of ACKs regarding whether the transmission of the MPDUs 540-1 and 540-3 transmitted through each spatial stream is successful. The transmitting station 510 may search for an optimal MCS (e.g., an MCS having the fastest transmission rate, an MCS having the highest stability, and/or an MCS determined through a trade-off between a transmission rate and stability) for each of the plurality of spatial streams, based on the plurality of ACKs. The transmitting station 510 may search for an MCS to be applied to each spatial stream through a sampling-based search method in real time. This is described in greater detail below with reference to FIGS. 8A and 8B.

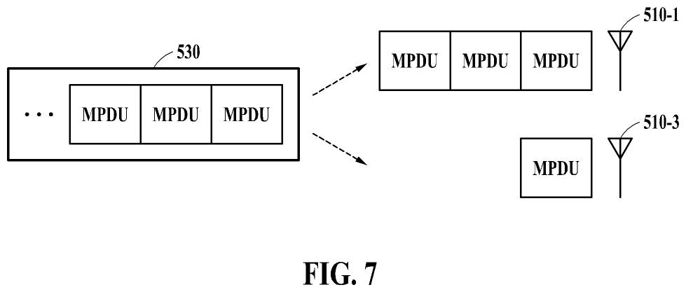

According to an embodiment, when the spatial streams to which different MCSs are applied transmit the MPDUs 540-1 and 540-3 independently, the receiving station 520 may be out of sync. This may be because the transmission rates of the spatial streams for each MCS are different. The transmitting station 510 may distribute the plurality of MPDUs 540-1 and 540-3 to the plurality of spatial streams based on the MCSs applied to the plurality of spatial streams to synchronize the spatial streams. This is described in greater detail below with reference to FIG. 7.

FIGS. 6A and 6B are diagrams illustrating an example structure of a PPDU, according to various embodiments.

FIG. 6A illustrates a general structure of a PPDU 600. The PPDU 600 may be a basic unit of a frame transmitted from a WLAN system of IEEE 802.11. The PPDU 600 may include a PLCP preamble 601, a PLCP header 602, and a PLCP SDU (PSDU) 603.

The PSDU 603 may include a MAC header, an MSDU, and an FCS. The reason that the PPDU 600 is a basic unit of transmission may be because an FCS field for decoding an error during data transmission is included for each PPDU. Through the FCS field, Wi-Fi devices (e.g., a transmitting station (e.g., the transmitting station 310 of FIG. 3B and/or the transmitting station 510 of FIG. 5) and a receiving station (e.g., the receiving station 330 of FIG. 3B and/or the receiving station 520 of FIG. 5)) may inspect whether an error exists in data included in the PPDU 600. Through the FCS field, the Wi-Fi devices may perform reliable data transmission and reception.

Furthermore, when data is transmitted and received by including one data frame in the PPDU 600, the efficiency of Wi-Fi communication competing channels for one transmission attempt (e.g., transmission attempt of one PPDU) may be reduced. Accordingly, the concept of frame aggregation may be introduced to Wi-Fi, allowing multiple data frames to be transmitted at a time.

FIG. 6B illustrates an example of PPDUs 606 and 604 (e.g., the PPDU 530 of FIG. 5) to which frame aggregation is applied. According to the frame aggregation method, a structure of a data frame included in a PSDU may be classified into aggregated (A)-MSDU and A-MPDU. The transmitting station 510 may perform frame aggregation to have an A-MPDU structure to verify a transmission error through the FCS field for each MPDU.

The A-MSDU (e.g., an A-MSDU of the PPDU 606) may be obtained by compressing information about multiple data frames into one MAC header. The A-MPDU (e.g., an A-MPDU of the PPDU 604) may be obtained by adding MAC headers for each of the multiple data frames and then compressing the multiple data frames. Since each MAC header includes an FCS for error detection, A-MSDU may be vulnerable to errors because only one FCS exists in the A-MSDU. However, since the FCS exists for each MPDU (e.g., 605), the A-MPDU may easily determine which data frame (e.g., MPDU) has an error.

FIG. 7 is a diagram illustrating an example operation of allocating an MPDU to a spatial stream, according to various embodiments.

Referring to FIG. 7, according to an embodiment, a transmitting station (e.g., the transmitting station 310 of FIGS. 3A and 3B and the transmitting station 510 of FIG. 5) may allocate a plurality of MPDUs to a plurality of spatial streams based on MCSs applied to the plurality of spatial streams. As described with reference to FIG. 5, when the MCSs applied to the plurality of spatial streams are different from each other, the transmission rates of the plurality of spatial streams may be different from each other. Since the transmission rates of the plurality of spatial streams are different from each other, each spatial stream may be out of sync in a receiving station (e.g., the receiving station 330 of FIGS. 3A and 3B and the receiving station 520 of FIG. 5). For example, 4K-QAM may be applied to the spatial stream of the antenna 510-1 and 16-QAM may be applied to the spatial stream of the antenna 510-3. The transmission rate of the spatial stream of the antenna 510-1 may be three times faster than that of the spatial stream of the antenna 510-3. For example, when a first MPDU and a second MPDU having the same size are independently allocated and transmitted to the spatial stream of the antenna 510-1 and the spatial stream of the antenna 510-3, the first MPDU may be transmitted to the receiving station 520 first.

According to an embodiment, the transmitting station 510 may add null data to a spatial stream with a fast transmission rate to synchronize each spatial stream. For example, the transmitting station 510 may add null data to the first MPDU so that the first MPDU and the second MPDU arrive at the receiving station 520 simultaneously. Null data may be added to the first MPDU so that the size of the first MPDU becomes three times larger than that of the second MPDU. The transmission rate of the spatial stream of the antenna 510-1 is three times faster than that of the spatial stream of the antenna 510-3 but the size of the first MPDU is three times larger than that of the second MPDU, so the first MPDU and the second MPDU may arrive at the receiving station 520 simultaneously. However, null data is added only to synchronize each spatial stream, so there may be problems such as reduced transmission efficiency, waste of network resources, and/or increased energy consumption. Hereinafter, a method of allocating an MPDU to a spatial stream to synchronize each spatial stream based on an MCS, instead of adding null data, is described in greater detail.

According to an embodiment, the transmitting station 510 may calculate the transmission rates of the plurality of spatial streams according to the MCSs applied to the plurality of spatial streams. The transmitting station 510 may distribute the plurality of MPDUs to the plurality of spatial streams based on the transmission rates of the plurality of spatial streams and the sizes of the plurality of MPDUs. The transmitting station 510 may distribute an MPDU of a first size to a spatial stream of a first transmission rate and distribute an MPDU of a second size to a spatial stream of a second transmission rate. The first transmission rate and the second transmission rate may be different from each other, and the first size and the second size may be different from each other. The transmitting stream 510 may distribute the MPDUs included in the PPDU 530 in proportion to the transmission rate of the spatial stream. For example, it may be assumed that the first transmission rate is faster than the second transmission rate and the first size is larger than the second size. When the first transmission rate is three times faster than the second transmission rate, the transmitting station 510 may distribute the MPDUs so that the first size becomes three times larger than the second size. For example, when 4K-QAM is applied to the spatial stream of the antenna 510-1 and 16-QAM is applied to the spatial stream of the antenna 510-3, the transmission rate (e.g., the first transmission rate) of the spatial stream of the antenna 510-1 may be three times faster than the transmission rate (e.g., the second transmission rate) of the spatial stream of the antenna 510-3. The transmitting station 510 may allocate, to the spatial stream of the antenna 510-1, an MPDU having a size three times larger than that of the spatial stream of the antenna 510-3. When the amounts of data of the MPDUs included in the PPDU 530 are all the same, the transmitting station 510 may distribute, to the spatial stream of the antenna 510-1, three times more MPDUs than the spatial stream of the antenna 510-3. When the amounts of data of the MPDUs included in the PPDU 530 are not all the same, the transmitting station 510 may distribute the MPDUs such that the amounts of data of the MPDUs allocated to the spatial stream of the antenna 510-1 are three times greater than the amounts of data of the MPDUs allocated to the spatial stream of the antenna 510-1.

FIGS. 8A and 8B include a flowchart and a diagram illustrating an example method of searching for an optimal MCS for each spatial stream, according to various embodiments.

Referring to FIG. 8A, according to an embodiment, operations 805, 810 and 815 (which may be referred to as operations 805 to 815) may be performed sequentially but not necessarily. For example, the order of operations 805 to 815 may be changed, and at least two of operations 805 to 815 may be performed in parallel.

According to an embodiment, at a time previous to operation 805, the transmitting station 510 may transmit a PPDU to the receiving station 520 by applying different MCSs for each spatial stream (e.g., corresponding to each of the antenna 510-1 and the antenna 510-3) to which different MPDUs are independently allocated. Hereinafter, for ease of description, a spatial stream of the antenna 510-1 may be referred to as a first spatial stream, an MPDU allocated to the first spatial stream may be referred to as a first MPDU, and an MCS applied to the first spatial stream may be referred to as a first MCS. Similarly, a spatial stream of the antenna 510-3 may be referred to as a second spatial stream, an MPDU allocated to the second spatial stream may be referred to as a second MPDU, and an MCS applied to the second spatial stream may be referred to as a second MCS.

In operation 805, the transmitting station 510 may check whether the transmission of an MPDU is successful. The receiving station 520 may check whether the transmission of a PPDU transmitted at the previous time from the transmission station 510 is successful for each MPDU included in the PPDU. The receiving station 520 may check whether the transmission for each MPDU is successful through an FCS field for each MPDU. The receiving station 520 may transmit, to the transmitting station 510, a plurality of ACKs regarding whether the transmission of each of the MPDUs is successful. The transmitting station 510 may verify sequence number information included in the plurality of ACKs and verify which MPDU each ACK corresponds to. Based on one ACK among the plurality of ACKs, the transmitting station 510 may check whether the transmission of an MPDU corresponding to the one ACK is successful.

According to an embodiment, as shown in FIG. 8B, the receiving station 520 may transmit ACK info (e.g., the plurality of ACKs regarding whether the transmission of each of the MPDUs is successful) to the transmitting station 510. For example, the receiving station 520 may verify whether the first MPDU is transmitted normally through an FCS field of the first MPDU transmitted through the first spatial stream. The receiving station 520 may transmit, to the transmitting station 510, an ACK regarding whether the transmission of the first MDPU is successful. In addition, for the second MPDU, the receiving station 520 may transmit the ACK in substantially the same manner as the first MPDU.

According to an embodiment, as shown in FIG. 8B, the transmitting station 510 may filter ACK info based on the sequence number information. For example, the transmitting station 510 may receive, from the receiving station 520, a plurality of ACKs (e.g., including an ACK regarding whether the transmission of the first MDPU is successful and an ACK regarding whether the transmission of the second MDPU is successful). The transmitting station 510 may recognize the plurality of ACKs separately for each MPDU. The transmitting station 510 may verify the sequence number information included in the plurality of ACKs and verify which MPDU each ACK corresponds to. The transmitting station 510 may check whether the transmission of the first MPDU is successful by verifying the sequence number information of the first MPDU included in the ACK (e.g., ACK regarding whether the transmission of the first MDPU is successful). For the second MPDU, the transmitting station 510 may check whether the transmission is successful in substantially the same manner as the first MPDU.

Hereinafter, it may be assumed that the transmission of the first MPDU is successful and the transmission of the second MPDU fails.

In operation 810, the transmitting station 510 may update a PER table of a spatial stream to which an MPDU is allocated. The PER table may include information about a PER for each MCS of the spatial stream.

According to an embodiment, as shown in FIG. 8B, the PER table for each spatial stream may be generated. The first spatial stream and the second spatial stream to which different MCSs (e.g., the first MCS and the second MCS) are applied may be involved in the transmission of the first MPDU and the transmission of the second MPDU, respectively, so the PER for each MCS of the first spatial stream and the PER for each MCS of the second spatial stream may be independently calculated. For example, when the transmission of the first MPDU is successful, the transmitting station 510 may reflect the PER of the first spatial stream according to the first MCS in the PER table of the first spatial stream. Similarly, when the transmission of the second MPDU is successful, the transmitting station 510 may reflect the PER of the second spatial stream according to the second MCS in the PER table of the second spatial stream. As described above, the PER according to an MCS is calculated independently for each spatial stream, so the PER table for each spatial stream may also be updated independently.

In operation 815, the transmitting station 510 may perform sampling according to an MCS having the fastest transmission rate. The transmitting station 510 may calculate the MCS having the fastest transmission rate for each spatial stream through a sampling-based search method based on the updated PER table. Since the PER according to the MCS is independently calculated for each spatial stream, the transmitting station 510 may perform the sampling-based search method for each spatial stream. The sampling-based search method is described in detail above with reference to FIG. 3B, so any repeated description may not be provided here.

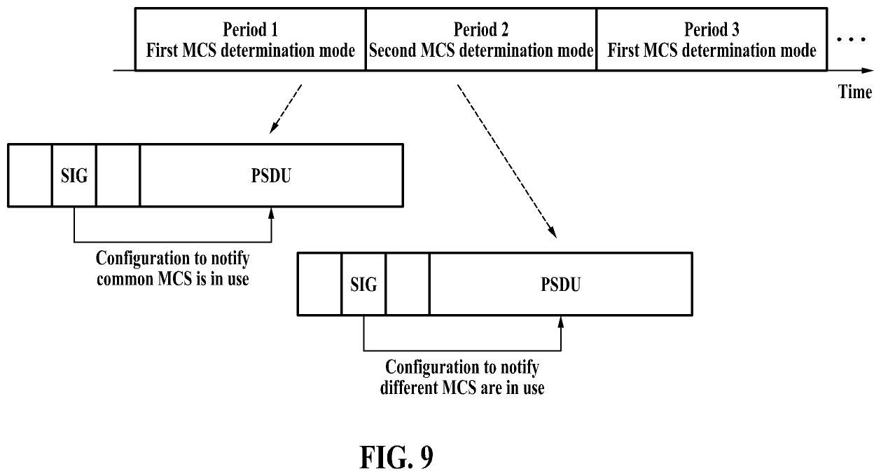

FIG. 9 is a diagram illustrating an example method of applying an MCS by variably applying an MCS determination mode, according to various embodiments.

Referring to FIG. 9, according to an embodiment, a transmitting station (e.g., the transmitting station 310 of FIGS. 3A and 3B and the transmitting station 510 of FIG. 5) may verify the communication quality (e.g., SNR) for each of a plurality of spatial streams based on an MCS applied to the plurality of spatial streams for PPDU transmission. The transmitting station 510 may determine the MCS in a different manner according to an MCS determination mode based on the difference in the communication quality for each of the plurality of spatial streams. The MCS determination mode may include a first MCS determination mode (e.g., when applying the same MCS to the plurality of spatial streams) and a second MCS determination mode (e.g., when applying different MCSs to the plurality of spatial streams).

According to an embodiment, the transmitting station 510 may apply an MCS to the plurality of spatial streams according to the first MCS determination mode when the difference in the communication quality for each of the plurality of spatial streams is small. For example, there may be no difference in the channel quality between a plurality of antennas (e.g., the antenna 510-1 and the antenna 510-3 of FIG. 5). In this case, even when the same MCS is applied to the spatial streams of the antenna 510-1 and the antenna 510-3, the difference in the SNR for each spatial stream may be small. For example, the transmitting station 510 may apply the same MCS to the spatial streams of the antenna 510-1 and the antenna 510-3 through the first MCS determination mode when the difference in the SNR for each spatial stream is small.

According to an embodiment, the transmitting station 510 may apply an MCS to the plurality of spatial streams according to the second MCS determination mode when the difference in the communication quality for each of the plurality of spatial streams is large. For example, when the channel quality of a portion of the plurality of antennas (e.g., the antenna 510-1 and the antenna 510-3 of FIG. 5) is low, a large difference may occur in the communication quality for each spatial stream of the plurality of antennas. For example, the channel quality of the antenna 510-1 may be high and the channel quality of the antenna 510-3 may be low. In this case, despite the difference in the channel quality between the antenna 510-1 and the antenna 510-3, when the same MCS is applied to the spatial streams of the antenna 510-1 and the antenna 510-3, a large difference in the SNR for each spatial stream may occur. For example, the transmitting station 510 may apply different MCSs to the spatial streams of the antenna 510-1 and the antenna 510-3 through the second MCS determination mode when a large difference occurs in the SNR for each spatial stream.

According to an embodiment, as shown in FIG. 9, the transmitting station 510 may alternately determine the first MCS determination mode and the second MCS determination mode depending on the difference in the communication quality for each of the plurality of spatial streams.

According to an embodiment, information about the MCS determination mode may be stored in a signal (SIG) field (e.g., included in a PHY header (PHYHDR) illustrated in FIG. 6B) in a PPDU (e.g., the PPDU 530 of FIG. 5). For example, information about which MCS determination mode the PPDU 530 transmitted from the transmitting station 510 is generated through may be stored in the SIG field in the PPDU 530. The receiving station 520 may verify, through the SIG field in the PPDU 530, which MCS determination mode the PPDU 530 is generated through. When the PPDU 530 is generated through the first MCS determination mode, the receiving station 520 may verify that the same MCS is used for each spatial stream. When the PPDU 530 is generated through the second MCS determination mode, the receiving station 520 may verify that different MCSs are used for each spatial stream.

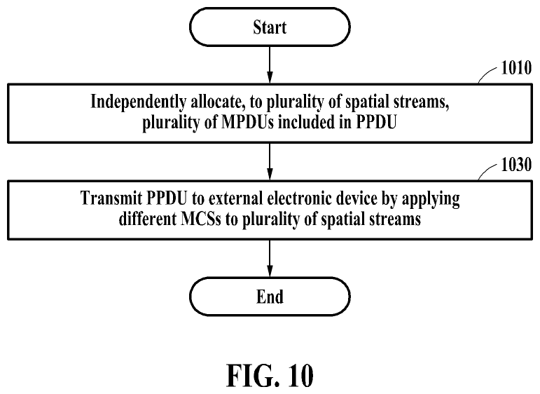

FIG. 10 is a flowchart illustrating an example PDU transmission method, according to various embodiments.

Referring to FIG. 10, according to an embodiment, operations 1010 and 1030 may be performed sequentially but not necessarily. For example, the order of operations 1010 and 1030 may be changed, and at least two of operations 1010 and 1030 may be performed in parallel.

In operation 1010, a transmitting station (e.g., the transmitting station 310 of FIGS. 3A and 3B and the transmitting station 510 of FIG. 5) may independently allocate, to a plurality of spatial streams, a plurality of MPDUs (e.g., the MPDUs 540-1 and 540-3 of FIG. 5) included in a PPDU (e.g., the PPDU 530 of FIG. 5). The plurality of spatial streams may correspond to a plurality of antennas (e.g., the antenna 510-1 and the antenna 510-3 of FIG. 5) included in the transmitting station 510, respectively.

In operation 1030, the transmitting station 510 may transmit the PPDU 530 to an external electronic device (e.g., the receiving station 520 of FIG. 5) by applying different MCSs to the plurality of spatial streams.

According to an embodiment, the transmitting station 510 may distribute the MPDUs based on an MCS applied to the plurality of spatial streams to synchronize the plurality of spatial streams. This is described in detail above with reference to FIG. 7, so the description thereof may not be repeated here.

According to an embodiment, the transmitting station 510 may apply an optimal MCS (e.g., an MCS having the fastest transmission rate, an MCS having the highest stability, and/or an MCS determined through a trade-off between a transmission rate and stability) for each of the plurality of spatial streams based on an ACK received from the receiving station 520. This is described in detail above with reference to FIGS. 8A and 8B, so the description thereof may not be repeated here.

FIG. 11 is a block diagram illustrating an example electronic device in a network environment, according to various embodiments.

Referring to FIG. 11, in a network environment 1100, an electronic device 1101 (e.g., the transmitting station 310 of FIGS. 3A and 3B and the transmitting station 510 of FIG. 5) may communicate with an electronic device 1102 via a first network 1198 (e.g., a short-range wireless communication network), or may communicate with at least one of an electronic device 1104 or a server 1108 via a second network 1199 (e.g., a long-range wireless communication network). According to an embodiment, the electronic device 1101 may communicate with the electronic device 1104 via the server 1108. According to an embodiment, the electronic device 1101 may include a processor 1120, memory 1130, an input module 1150, a sound output module 1155, a display module 1160, an audio module 1170, a sensor module 1176, an interface 1177, a connecting terminal 1178, a haptic module 1179, a camera module 1180, a power management module 1188, a battery 1189, a communication module 1190, a subscriber identification module (SIM) 1196, or an antenna module 1197. In various embodiments, at least one of the components (e.g., the connecting terminal 1178) may be omitted from the electronic device 1101, or one or more other components may be added to the electronic device 1101. In various embodiments, some of the components (e.g., the sensor module 1176, the camera module 1180, or the antenna module 1197) may be integrated as a single component (e.g., the display module 1160).

The processor 1120 may execute, for example, software (e.g., a program 1140) to control at least one other component (e.g., a hardware or software component) of the electronic device 1101 connected to the processor 1120 and may perform various data processing or computations. According to an embodiment, as at least part of data processing or computations, the processor 1120 may store a command or data received from another component (e.g., the sensor module 1176 or the communication module 1190) in a volatile memory 1132, process the command or the data stored in the volatile memory 1132, and store result data in a non-volatile memory 1134. According to an embodiment, the processor 1120 may include a main processor 1121 (e.g., a central processing unit (CPU) or an application processor (AP)), or an auxiliary processor 1123 (e.g., a graphics processing unit (GPU), a neural processing unit (NPU), an image signal processor (ISP), a sensor hub processor, or a communication processor (CP)) that is operable independently of, or in conjunction with the main processor 1121. For example, when the electronic device 1101 includes the main processor 1121 and the auxiliary processor 1123, the auxiliary processor 1123 may be adapted to consume less power than the main processor 1121 or to be specialized for a specified function. The auxiliary processor 1123 may be implemented separately from the main processor 1121 or as a part of the main processor 1121. Thus, the processor 1120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The auxiliary processor 1123 may control at least some of functions or states related to at least one (e.g., the display module 1160, the sensor module 1176, or the communication module 1190) of the components of the electronic device 1101, instead of the main processor 1121 while the main processor 1121 is in an inactive (e.g., sleep) state or along with the main processor 1121 while the main processor 1121 is in an active state (e.g., executing an application). According to an embodiment, the auxiliary processor 1123 (e.g., an ISP or a CP) may be implemented as part of another component (e.g., the camera module 1180 or the communication module 1190) that is functionally related to the auxiliary processor 1123. According to an embodiment, the auxiliary processor 1123 (e.g., an NPU) may include a hardware structure specialized for artificial intelligence model processing. An artificial intelligence model may be generated by machine learning. Such learning may be performed, for example, by the electronic device 1101 in which an artificial intelligence model is executed, or via a separate server (e.g., the server 1108). Learning algorithms may include, but are not limited to, e.g., supervised learning, unsupervised learning, semi-supervised learning, or reinforcement learning. The AI model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), and a bidirectional recurrent deep neural network (BRDNN), a deep Q-network, or a combination of two or more thereof, but is not limited thereto. The artificial intelligence model may additionally or alternatively include a software structure other than the hardware structure.

The memory 1130 may store various pieces of data used by at least one component (e.g., the processor 1120 or the sensor module 1176) of the electronic device 1101. The various pieces of data may include, for example, software (e.g., the program 1140) and input data or output data for a command related thereto. The memory 1130 may include the volatile memory 1132 or the non-volatile memory 1134.

The program 1140 may be stored as software in the memory 1130 and may include, for example, an operating system (OS) 1142, middleware 1144, or an application 1146.

The input module 1150 may receive, from the outside (e.g., a user) of the electronic device 1101, a command or data to be used by a component (e.g., the processor 1120) of the electronic device 1101. The input module 1150 may include, for example, a microphone, a mouse, a keyboard, a key (e.g., a button), or a digital pen (e.g., a stylus pen).

The sound output module 1155 may output a sound signal to the outside of the electronic device 1101. The sound output module 1155 may include, for example, a speaker or a receiver. The speaker may be used for general purposes, such as playing multimedia or playing a record. The receiver may be used to receive an incoming call. According to an embodiment, the receiver may be implemented separately from, or as part of, the speaker.

The display module 1160 may visually provide information to the outside (e.g., a user) of the electronic device 1101. The display module 1160 may include, for example, a display, a hologram device, or a projector and control circuitry to control a corresponding device. According to an embodiment, the display module 1160 may include a touch sensor configured to sense a touch, or a pressure sensor configured to measure the intensity of force incurred by the touch.

The audio module 1170 may convert sound into an electrical signal or vice versa. According to an embodiment, the audio module 1170 may obtain the sound via the input module 1150 or output the sound via the sound output module 1155 or an external electronic device (e.g., the electronic device 1102, such as a speaker or headphones) directly or wirelessly connected to the electronic device 1101.

The sensor module 1176 may detect an operational state (e.g., power or temperature) of the electronic device 1101 or an environmental state (e.g., a state of a user) external to the electronic device 1101, and generate an electrical signal or data value corresponding to the detected state. According to an embodiment, the sensor module 1176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1177 may support one or more specified protocols to be used for the electronic device 1101 to be connected to the external electronic device (e.g., the electronic device 1102) directly (e.g., by wire) or wirelessly. According to an embodiment, the interface 1177 may include, for example, a high-definition multimedia interface (HDMI), a universal serial bus (USB) interface, a secure digital (SD) card interface, or an audio interface.

The connecting terminal 1178 may include a connector via which the electronic device 1101 may be physically connected to the external electronic device (e.g., the electronic device 1102). According to an embodiment, the connecting terminal 1178 may include, for example, an HDMI connector, a USB connector, an SD card connector, or an audio connector (e.g., a headphones connector).

The haptic module 1179 may convert an electrical signal into a mechanical stimulus (e.g., a vibration or a movement) or an electrical stimulus, which may be recognized by a user via tactile sensation or kinesthetic sensation. According to an embodiment, the haptic module 1179 may include, for example, a motor, a piezoelectric element, or an electric stimulator.

The camera module 1180 may capture a still image and a moving image. According to an embodiment, the camera module 1180 may include one or more lenses, image sensors, image signal processors, or flashes.

The power management module 1188 may manage power supplied to the electronic device 1101. According to an embodiment, the power management module 1188 may be implemented as, for example, at least part of a power management integrated circuit (PMIC). The battery 1189 may supply power to at least one component of the electronic device 1101. According to an embodiment, the battery 1189 may include, for example, a primary cell which is not rechargeable, a secondary cell which is rechargeable, or a fuel cell.

The communication module 1190 may support establishing a direct (e.g., wired) communication channel or a wireless communication channel between the electronic device 1101 and the external electronic device (e.g., the electronic device 1102, the electronic device 1104, or the server 1108) and performing communication via the established communication channel. The communication module 1190 may include one or more CPs that are operable independently of the processor 1120 (e.g., an AP) and that support direct (e.g., wired) communication or wireless communication. According to an embodiment, the communication module 1190 may include a wireless communication module 1192 (e.g., a cellular communication module, a short-range wireless communication module, or a global navigation satellite system (GNSS) communication module) or a wired communication module 1194 (e.g., a local area network (LAN) communication module, or a power line communication (PLC) module). A corresponding one of these communication modules may communicate with the external electronic device 1104 via the first network 1198 (e.g., a short-range communication network, such as Bluetooth™, wireless-fidelity (Wi-Fi) direct, or infrared data association (IrDA)) or the second network 1199 (e.g., a long-range communication network, such as a legacy cellular network, a 5G network, a next-generation communication network, the Internet, or a computer network (e.g., a LAN or a wide region network (WAN)). These various types of communication modules may be implemented as a single component (e.g., a single chip) or may be implemented as multiple components (e.g., multiple chips) separate from each other. The wireless communication module 1192 may identify or authenticate the electronic device 1101 in a communication network, such as the first network 1198 or the second network 1199, using subscriber information (e.g., international mobile subscriber identity (IMSI)) stored in the SIM 1196.

The wireless communication module 1192 may support a 5G network after a fourth-generation (4G) network, and next-generation communication technology, for example, new radio (NR) access technology. The NR access technology may support enhanced mobile broadband (eMBB), massive machine type communications (mMTC), or ultra-reliable and low-latency communications (URLLC). The wireless communication module 1192 may support a high-frequency band (e.g., a mmWave band) to achieve, e.g., a high data transmission rate. The wireless communication module 1192 may support various technologies for securing performance on a high-frequency band, such as, e.g., beamforming, massive multiple-input and multiple-output (MIMO), full dimensional MIMO (FD-MIMO), an array antenna, analog beam-forming, or a large scale antenna. The wireless communication module 1192 may support various requirements specified in the electronic device 1101, an external electronic device (e.g., the electronic device 1104), or a network system (e.g., the second network 1199). According to an embodiment, the wireless communication module 1192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 1197 may transmit or receive a signal or power to or from the outside (e.g., an external electronic device) of the electronic device 1101. According to an embodiment, the antenna module 1197 may include an antenna including a radiating element including a conductive material or a conductive pattern formed in or on a substrate (e.g., a printed circuit board (PCB)). According to an embodiment, the antenna module 1197 may include a plurality of antennas (e.g., array antennas). In such a case, at least one antenna appropriate for a communication scheme used in a communication network, such as the first network 1198 or the second network 1199, may be selected by, for example, the communication module 1190 from the plurality of antennas. The signal or power may be transmitted or received between the communication module 1190 and the external electronic device via the at least one selected antenna. According to an embodiment, another component (e.g., a radio frequency integrated circuit (RFIC)) other than the radiating element may be additionally formed as a part of the antenna module 1197. According to various embodiments, the antenna module 1197 may form a mmWave antenna module. According to an embodiment, the mmWave antenna module may include a PCB, an RFIC disposed on a first surface (e.g., a bottom surface) of the PCB or adjacent to the first surface and capable of supporting a designated high-frequency band (e.g., a mmWave band), and a plurality of antennas (e.g., array antennas) disposed on a second surface (e.g., a top or a side surface) of the PCB, or adjacent to the second surface and capable of transmitting or receiving signals in the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1101 and the external electronic device 1104 via the server 1108 coupled with the second network 1199. Each of the external electronic devices 1102 or 1104 may be a device of the same type as or a different type from the electronic device 1101. According to an embodiment, all or some of operations to be executed by the electronic device 1101 may be executed by one or more external electronic devices (e.g., the external electronic devices 1102, 1104, or 1108). For example, if the electronic device 1101 needs to perform a function or a service automatically, or in response to a request from a user or another device, the electronic device 1101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and may transfer an outcome of the performing to the electronic device 1101. The electronic device 1101 may provide the outcome, with or without further processing of the outcome, as at least part of a reply to the request. To this end, cloud computing, distributed computing, mobile edge computing (MEC), or client-server computing technology may be used, for example. The electronic device 1101 may provide ultra low-latency services using, e.g., distributed computing or MEC. In an embodiment, the external electronic device 1104 may include an Internet-of-things (IoT) device. The server 1108 may be an intelligent server using machine learning and/or a neural network. According to an embodiment, the external electronic device 1104 or the server 1108 may be included in the second network 1199. The electronic device 1101 may be applied to intelligent services (e.g., smart home, smart city, smart car, or healthcare) based on 5G communication technology or IoT-related technology.

According to an embodiment, an electronic device (e.g., the transmitting station 310 of FIGS. 3A and 3A, the transmitting station 510 of FIG. 5, and the electronic device 1101 of FIG. 11) may include a wireless communication module (e.g., the wireless communication module 410 of FIG. 4 and the communication module 1190 of FIG. 11). The electronic device (310, 510, 1101) may include at least one processor (e.g., the processor 420 of FIG. 4 and the processor 1120 of FIG. 11) including processing circuitry. The electronic device (310, 510, 1101) may include memory (e.g., the memory 430 of FIG. 4 and the memory 1130 of FIG. 11) storing instructions. The instructions, when executed by the at least one processor (420, 1120) individually or collectively, may cause the electronic device (310, 510, 1101) to independently allocate, to a plurality of spatial streams, a plurality of MPDUs included in a PPDU. The instructions, when executed by the at least one processor (420, 1120) individually or collectively, may cause the electronic device (310, 510, 1101) to transmit the PPDU to an external electronic device (e.g., the receiving station 330 of FIGS. 3A and 3B and the receiving station 520 of FIG. 5) through the wireless communication module (410, 1190) by applying different MCSs to the plurality of spatial streams.

According to an embodiment, the instructions, when executed by the at least one processor (420, 1120) individually or collectively, may cause the electronic device (310, 510, 1101) to allocate the plurality of MPDUs to the plurality of spatial streams based on the different MCSs applied to the plurality of spatial streams.

According to an embodiment, the instructions, when executed by the at least one processor (420, 1120) individually or collectively, may cause the electronic device (310, 510, 1101) to calculate transmission rates of the plurality of spatial streams according to the different MCSs applied to the plurality of spatial streams. The instructions, when executed by the at least one processor (420, 1120) individually or collectively, may cause the electronic device (310, 510, 1101) to distribute the plurality of MPDUs to the plurality of spatial streams based on transmission rates of the plurality of spatial streams and sizes of the plurality of MPDUs.

According to an embodiment, the instructions, when executed by the at least one processor (420, 1120) individually or collectively, may cause the electronic device (310, 510, 1101) to distribute an MPDU of a first size to a spatial stream of a first transmission rate. The instructions, when executed by the at least one processor (420, 1120) individually or collectively, may cause the electronic device (310, 510, 1101) to distribute an MPDU of a second size to a spatial stream of a second transmission rate. The first transmission rate and the second transmission rate may be different from each other. The first size and the second size may be different from each other.

According to an embodiment, the first transmission rate may be faster than the second transmission rate. The first size may be larger than the second size.

According to an embodiment, the instructions, when executed by the at least one processor (420, 1120) individually or collectively, may cause the electronic device (310, 510, 1101) to receive, from the external electronic device (330, 520), a plurality of ACKs regarding whether transmission of each of the plurality of MPDUs included in the PPDU is successful through the wireless communication module (410, 1190). The instructions, when executed by the at least one processor (420, 1120) individually or collectively, acknowledgements cause the electronic device (310, 510, 1101) to apply an MCS having the fastest transmission rate for each of the plurality of spatial streams to which the plurality of MPDUs is allocated, based on the plurality of ACKs.

According to an embodiment, the instructions, when executed by the at least one processor (420, 1120) individually or collectively, may cause the electronic device (310, 510, 1101) to, based on one ACK among the plurality of ACKs, update a PER table including information about a PER for each MCS of spatial streams to which an MPDU corresponding to the one ACK is allocated. The instructions, when executed by the at least one processor (420, 1120) individually or collectively, may cause the electronic device (310, 510, 1101) to calculate the MCS having the fastest transmission rate based on the updated PER table.

According to an embodiment, an operating method of an electronic device (e.g., the transmitting station 310 of FIG. 3A and FIG. 3, the transmitting station 510 of FIG. 5, and the electronic device 1101 of FIG. 11) may include independently allocating, to a plurality of spatial streams, a plurality of MPDUs included in a PPDU. The operating method may include transmitting the PPDU to an external electronic device (e.g., the receiving station 330 of FIGS. 3A and 3B and the receiving station 520 of FIG. 5) by applying different MCSs to the plurality of spatial streams.

According to an embodiment, the independently allocating of the plurality of MPDUs to the plurality of spatial streams may include allocating the plurality of MPDUs to the plurality of spatial streams based on the different MCSs applied to the plurality of spatial streams.

According to an embodiment, the allocating of the plurality of MPDUs to the plurality of spatial streams based on the different MCSs applied to the plurality of spatial streams may include calculating transmission rates of the plurality of spatial streams according to the different MCSs applied to the plurality of spatial streams. The allocating of the plurality of MPDUs to the plurality of spatial streams based on the different MCSs applied to the plurality of spatial streams may include distributing the plurality of MPDUs to the plurality of spatial streams based on the transmission rates of the plurality of spatial streams and sizes of the plurality of MPDUs.

According to an embodiment, the distributing of the plurality of MPDUs to the plurality of spatial streams may include distributing an MPDU of a first size to a spatial stream of a first transmission rate. The distributing of the plurality of MPDUs to the plurality of spatial streams may include distributing an MPDU of a second size to a spatial stream of a second transmission rate. The first transmission rate and the second transmission rate may be different from each other. The first size and the second size may be different from each other.

According to an embodiment, the first transmission rate may be faster than the second transmission rate. The first size may be larger than the second size.

According to an embodiment, the operating method may include receiving, from the external electronic device (330, 520), a plurality of ACKs regarding whether transmission of each of the plurality of MPDUs included in the PPDU is successful. The operating method may include applying an MCS having the fastest transmission rate for each of the plurality of spatial streams to which the plurality of MPDUs is allocated, based on the plurality of ACKs.

According to an embodiment, the applying of the MCS having the fastest transmission rate for each of the plurality of spatial streams to which the plurality of MPDUs is allocated may include, based on one ACK among the plurality of ACKs, updating a PER table including information about a PER for each MCS of spatial streams to which an MPDU corresponding to the one ACK is allocated. The applying of the MCS having the fastest transmission rate for each of the plurality of spatial streams to which the plurality of MPDUs is allocated may include calculating the MCS having the fastest transmission rate based on the updated PER table.

According to an embodiment, an electronic device (e.g., the transmitting station 310 of FIGS. 3A and 3A, the transmitting station 510 of FIG. 5, and the electronic device 1101 of FIG. 11) may include a wireless communication module (e.g., the wireless communication module 410 of FIG. 4 and the communication module 1190 of FIG. 11). The electronic device (310, 510, 1101) may include at least one processor (e.g., the processor 420 of FIG. 4 and the processor 1120 of FIG. 11) including processing circuitry. The electronic device (310, 510, 1101) may include memory (e.g., the memory 430 of FIG. 4 and the memory 1130 of FIG. 11) storing instructions. The instructions, when executed by the at least one processor (420, 1120) individually or collectively, may cause the electronic device (310, 510, 1101) to, based on an MCS applied to a plurality of spatial streams for transmission of a PPDU, verify communication quality for each of the plurality of spatial streams. The instructions, when executed by the at least one processor (420, 1120) individually or collectively, may cause the electronic device (310, 510, 1101) to determine the MCS in a different manner according to an MCS determination mode based on a difference in the communication quality for each of the plurality of spatial streams.

According to an embodiment, the MCS determination mode may a first MCS determination mode and a second MCS determination mode. The first MCS determination mode may be configured to apply the same MCS to the plurality of spatial streams. The second MCS determination mode may be configured to apply different MCSs to the plurality of spatial streams.

According to an embodiment, the instructions, when executed by the at least one processor (420, 1120) individually or collectively, may cause the electronic device (310, 510, 1101) to select the first MCS determination mode when the difference in the communication quality for each of the plurality of spatial streams is small. The instructions, when executed by the at least one processor (420, 1120) individually or collectively, may cause the electronic device (310, 510, 1101) to select the second MCS determination mode when the difference in the communication quality for each of the plurality of spatial streams is large.

According to an embodiment, the instructions, when executed by the at least one processor (420, 1120) individually or collectively, may cause the electronic device (310, 510, 1101) to, in the first MCS determination mode, overlappingly allocate, to the plurality of spatial streams, a plurality of MPDUs included in the PPDU. The instructions, when executed by the at least one processor (420, 1120) individually or collectively, may cause the electronic device (310, 510, 1101) to transmit the PPDU to an external electronic device (e.g., the receiving station 330 of FIGS. 3A and 3B and the receiving station 520 of FIG. 5) through the wireless communication module (410, 1190) by applying the same MCS to the plurality of spatial streams.

According to an embodiment, the instructions, when executed by the at least one processor (420, 1120) individually or collectively, may cause the electronic device (310, 510, 1101) to, in the second MCS determination mode, independently allocate, to the plurality of spatial streams, the plurality of MPDUs included in the PPDU. The instructions, when executed by the at least one processor (420, 1120) individually or collectively, may cause the electronic device (310, 510, 1101) to transmit the PPDU to an external electronic device (330, 520) through the wireless communication module (410, 1190) by applying different MCSs to the plurality of spatial streams.

According to an embodiment, a non-transitory computer-readable storage medium may store instructions. The instructions, when executed by at least one processor individually or collectively, may cause the at least one processor to perform the operating method.

The electronic device according to various embodiments may be one of various types of electronic devices. The electronic device may include, for example, a portable communication device (e.g., a smartphone), a computer device, a portable multimedia device, a portable medical device, a camera, a wearable device, a home appliance device, or the like. According to an embodiment of the disclosure, the electronic device is not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related components. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms such as “1st,” and “2nd,” or “first” and “second” may be used to simply distinguish a corresponding component from another, and do not limit the components in other aspect (e.g., importance or order). It is to be understood that if a component (e.g., a first component) is referred to, with or without the term “operatively” or “communicatively,” as “coupled with,” “coupled to,” “connected with,” or “connected to” another component (e.g., a second component), the component may be coupled with the other component directly (e.g., wiredly), wirelessly, or via a third component.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry.” A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1140) including one or more instructions that are stored in a storage medium (e.g., the internal memory 1136 or the external memory 1138) that is readable by a machine (e.g., the electronic device 1101) For example, a processor (e.g., the processor 1120) of the machine (e.g., the electronic device 1101) may invoke at least one of the one or more instructions stored in the storage medium, and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read-only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components or operations may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. An electronic device, comprising:
a wireless communication module comprising communication circuitry,
at least one processor comprising processing circuitry,
memory storing instructions, wherein at least one processor, individually or collectively, is configured to execute the instructions and to cause the electronic device to;
independently allocate, to a plurality of spatial streams, a plurality of medium access control (MAC) protocol data units (MPDUs) included in a physical layer convergence procedure (PLCP) PDU (PPDU), and
transmit the PPDU to an external electronic device through the wireless communication module by applying different modulation and coding schemes (MCSs) to the plurality of spatial streams.

2. The electronic device of claim 1, wherein at least one processor, individually or collectively, is configured to execute the instructions and to cause the electronic device to allocate the plurality of MPDUs to the plurality of spatial streams based on the different MCSs applied to the plurality of spatial streams.

3. The electronic device of claim 2, wherein at least one processor, individually or collectively, is configured to execute the instructions and to cause the electronic device to:
calculate transmission rates of the plurality of spatial streams according to the different MCSs applied to the plurality of spatial streams, and
distribute the plurality of MPDUs to the plurality of spatial streams based on the transmission rates of the plurality of spatial streams and sizes of the plurality of MPDUs.

4. The electronic device of claim 3, wherein at least one processor, individually or collectively, is configured to execute the instructions and to cause the electronic device to:
distribute an MPDU of a first size to a spatial stream of a first transmission rate, and
distribute an MPDU of a second size to a spatial stream of a second transmission rate,
wherein the first transmission rate and the second transmission rate are different from each other, and
wherein the first size and the second size are different from each other.

5. The electronic device of claim 4, wherein
the first transmission rate is faster than the second transmission rate, and
the first size is larger than the second size.

6. The electronic device of claim 1, wherein at least one processor, individually or collectively, is configured to execute the instructions and to cause the electronic device to:
receive, from the external electronic device, a plurality of acknowledgements (ACKs) regarding whether transmission of each of the plurality of MPDUs comprised in the PPDU is successful, through the wireless communication module, and
apply an MCS having a fastest transmission rate for each of the plurality of spatial streams to which the plurality of MPDUs is allocated, based on the plurality of ACKs.

7. The electronic device of claim 6, wherein at least one processor, individually or collectively, is configured to execute the instructions and to cause the electronic device to:
based on one ACK among the plurality of ACKs, update a packet error rate (PER) table comprising information about a PER for each MCS of spatial streams to which an MPDU corresponding to the one ACK is allocated, and
calculate the MCS having the fastest transmission rate based on the updated PER table.

8. A method performed by an electronic device, the method comprising:
independently allocating, to a plurality of spatial streams, a plurality of medium access control (MAC) protocol data units (MPDUs) comprised in a physical layer convergence procedure (PLCP) PDU (PPDU), and
transmitting the PPDU to an external electronic device by applying different modulation and coding schemes (MCSs) to the plurality of spatial streams.

9. The method of claim 8, wherein the independently allocating of the plurality of MPDUs to the plurality of spatial streams comprises allocating the plurality of MPDUs to the plurality of spatial streams based on the different MCSs applied to the plurality of spatial streams.

10. The method of claim 9, wherein the allocating of the plurality of MPDUs to the plurality of spatial streams based on the different MCSs applied to the plurality of spatial streams comprises:
calculating transmission rates of the plurality of spatial streams according to the different MCSs applied to the plurality of spatial streams, and
distributing the plurality of MPDUs to the plurality of spatial streams based on the transmission rates of the plurality of spatial streams and sizes of the plurality of MPDUs.

11. The method of claim 10, wherein the distributing of the plurality of MPDUs to the plurality of spatial streams comprises:
distributing an MPDU of a first size to a spatial stream of a first transmission rate, and
distributing an MPDU of a second size to a spatial stream of a second transmission rate,
wherein the first transmission rate and the second transmission rate are different from each other, and
wherein the first size and the second size are different from each other.

12. The method of claim 11, wherein
the first transmission rate is faster than the second transmission rate, and
the first size is larger than the second size.

13. The method of claim 8, further comprising:
receiving, from the external electronic device, a plurality of acknowledgements (ACKs) regarding whether transmission of each of the plurality of MPDUs comprised in the PPDU is successful, and
applying an MCS having a fastest transmission rate for each of the plurality of spatial streams to which the plurality of MPDUs is allocated, based on the plurality of ACKs.

14. The method of claim 13, wherein the applying of the MCS having the fastest transmission rate for each of the plurality of spatial streams to which the plurality of MPDUs is allocated comprises:
based on one ACK among the plurality of ACKs, updating a packet error rate (PER) table comprising information about a PER for each MCS of spatial streams to which an MPDU corresponding to the one ACK is allocated, and
calculating the MCS having the fastest transmission rate based on the updated PER table.

15. An electronic device, comprising:
a wireless communication module comprising communication circuitry,
at least one processor comprising processing circuitry, and
memory storing instructions, wherein at least one processor, individually or collectively, is configured to execute the instructions and to cause the electronic device to:
based on a modulation and coding scheme (MCS) applied to a plurality of spatial streams for transmission of a physical layer convergence procedure (PLCP) protocol data unit (PPDU), verify communication quality for each of the plurality of spatial streams, and
determine the MCS in a different manner according to an MCS determination mode based on a difference in the communication quality for each of the plurality of spatial streams.

16. The electronic device of claim 15, wherein the MCS determination mode comprises a first MCS determination mode and a second MCS determination mode,
wherein the first MCS determination mode is configured to apply the same MCS to the plurality of spatial streams, and
wherein the second MCS determination mode is configured to apply different MCSs to the plurality of spatial streams.

17. The electronic device of claim 16, wherein at least one processor, individually or collectively, is configured to cause the electronic device to:
select the first MCS determination mode based on the difference in the communication quality for each of the plurality of spatial streams being small, and
select the second MCS determination mode based on the difference in the communication quality for each of the plurality of spatial streams being large.

18. The electronic device of claim 16, wherein at least one processor, individually or collectively, is configured to cause the electronic device to:
in the first MCS determination mode, overlappingly allocate, to the plurality of spatial streams, a plurality of medium access control (MAC) PDUs (MPDUs) included in the PPDU, and
transmit the PPDU to an external electronic device through the wireless communication module by applying the same MCS to the plurality of spatial streams.

19. The electronic device of claim 16, wherein at least one processor, individually or collectively, is configured to cause the electronic device to:
in the second MCS determination mode, independently allocate, to the plurality of spatial streams, the plurality of MPDUs comprised in the PPDU, and
transmit the PPDU to an external electronic device through the wireless communication module by applying different MCSs to the plurality of spatial streams.

20. A non-transitory computer-readable storage medium storing instructions that, when executed by at least one processor, comprising processing circuitry, individually and/or collectively, of an electronic device, cause the electronic device to perform the method of claim 8.
